(19) United States
(12) Patent Application Publication
(10) Pub. No.: US 2026/0210398 A1
(43) Pub. Date: Jul. 23, 2026

(54) BEARING ASSEMBLY WITH GUIDE GROOVES AND AN AXIAL RETAINING MEMBER AND AN ASSOCIATED ASSEMBLY METHOD

(71) Applicant: SKF Aerospace France S.A.S, Perrigny (FR)

(72) Inventors: Florent RIVIERE, Lons Le Saunier (FR); Didier BAILLY, Digna (FR); Eve GOUJON, Perrigny (FR); Arnaud Jean Auguste TURMEAU, Chabeuil (FR); Zoran SAVIC, Orgelet (FR)

(21) Appl. No.: 19/445,964

(22) Filed: Jan. 12, 2026

(30) Foreign Application Priority Data
Jan. 17, 2025 (FR) FR2500495

(51) Int. Cl. F16C 11/06

(52) U.S. Cl. CPC F16C 11/0623; F16C 11/0685

(57) ABSTRACT

A bearing assembly includes a ball joint with an internal ring having an internal surface forming a bore and a spherical external surface, an external ring with a spherical internal surface mounted on the external surface of the internal ring, and a holding sleeve with an external surface mounted in the internal surface of the internal ring. Either the internal surface of the internal ring or the external surface of the holding sleeve is provided with at least one axial groove extending from a front face of the internal ring or the sleeve, at least one circumferential groove extending from the axial groove. The other surface is provided with at least one axial retaining member engaged in the axial groove and the circumferential groove so as to axially block the holding sleeve relative to the internal ring.

### CROSS-REFERENCE

This application claims priority to French patent application no. 2500495 filed on Jan. 17, 2025, the contents of which are fully incorporated herein by reference.

### BACKGROUND OF THE INVENTION

The present invention relates to bearing assemblies, and more particularly bearing assemblies of the ball joint type used in the aeronautical industry.

Certain bearing assemblies include an external ring provided with a spherical internal surface and an internal ring provided with a spherical external surface.

In the aeronautical industry, these assemblies are often installed on joints of the ball joint type in order to be adapted to structural deformations which can be caused by expansion.

During maintenance operations, these joints have to be dismantled in order to release the assembly.

To facilitate the mounting and the dismantling, the internal ring can be produced, in particular, in a plurality of parts, forming a split internal ring.

However, such a design can cause marks on the axis of the joint, requiring a costly replacement.

In order to remedy this drawback, it is known to mount a holding sleeve within the bore of the internal ring.

In order to form an integral assembly which is simple to mount and dismantle, it is necessary to secure the sleeve to the internal ring.

In the current art, known methods of mounting the holding sleeve, such as by the use of nuts, screws or clips, are often complex, costly and can damage the components.

Moreover, these methods increase the risk of losing parts, amongst other things, during maintenance or transport operations.

### SUMMARY OF THE INVENTION

An object of the present invention, therefore, is to remedy the above-discussed drawback by proposing a bearing assembly which comprises a ball joint provided with an internal ring including a spherical external surface forming a bore, an external ring comprising a spherical internal surface mounted on the spherical external surface of the internal ring and a holding sleeve provided with an external surface mounted in the internal surface of the internal ring.

Advantageously, one of the internal surface of the internal ring and the external surface of the holding sleeve is provided with at least one axial groove extending from a front face of the internal ring or the holding sleeve and at least one circumferential groove extending from the axial groove, and the other one of the internal surface of the internal ring and the external surface of the holding sleeve is provided with at least one axial retaining member configured to be engaged inside the axial groove and the circumferential groove for axially blocking the holding sleeve relative to the internal ring.

In this manner, the invention proposes a combination of axial and circumferential grooves cooperating with an axial retaining member to ensure a reliable axial blocking of the holding sleeve, thus preventing any longitudinal movement and the loss of the holding sleeve during transport or assembly.

In one possible embodiment, the holding sleeve is formed by two separate parts, each part being provided either with the axial retaining member or the axial and circumferential grooves.

Preferably, the axial retaining member comprises at least one lug which extends so as to protrude relative to the other of the internal surface of the internal ring and the external surface of the holding sleeve.

According to one aspect of the invention, the lug is formed in one piece with the other of the internal surface of the internal ring and the external surface of the holding sleeve.

According to a further aspect of the invention, the lug is attached to the other of the internal surface of the internal ring and the external surface of the holding sleeve.

In a further possible embodiment, wherein the internal ring comprises two internal half-rings in contact with one another, forming at least one joining zone, each joining zone is provided with at least one axial groove.

Moreover, the internal surface of each half-ring comprises at least one circumferential groove extending from the axial groove.

Moreover, the holding sleeve comprises at least one marking on the front face to indicate the position of the axial retaining member of the holding sleeve.

The invention also relates to an assembly method for a bearing assembly as defined above. The method comprises the following steps:
inserting the internal ring into the external ring;
engaging the axial retaining member of one of the internal surface of the internal ring and the external surface of the holding sleeve with the at least one axial groove of the other of the internal surface of the internal ring and the external surface of the holding sleeve; and
applying a relative rotational movement between the holding sleeve and the internal ring in order to permit the axial retaining member to be engaged in the circumferential groove of one of the internal surface of the internal ring and the external surface of the holding sleeve and to ensure the axial blocking of the holding sleeve relative to the internal ring.

Thus the axial securing of the holding sleeve and the internal ring is ensured in a practical manner by the engagement of the axial retaining member in the grooves.

### BRIEF DESCRIPTION OF THE SEVERAL VIEWS OF THE DRAWINGS

The present invention will be more clearly understood by studying the detailed description of embodiments, made by way of non-limiting example and illustrated by the accompanying drawings, in which:

FIG. 1 is a sectional view of a bearing assembly according to an exemplary embodiment of the invention,

FIG. 2 is a perspective view of a holding sleeve of the bearing assembly according to FIG. 1;

FIG. 3 is a perspective view of a holding sleeve of the bearing assembly according to a further exemplary embodiment;

FIG. 4 is a perspective view of an internal ring of the bearing assembly of FIG. 1;

FIG. 5 is a perspective view of an internal ring of the bearing assembly according to a further exemplary embodiment; and

FIG. 6 is a sectional view of the bearing assembly partially assembled, according to the exemplary embodiment illustrated in FIG. 1.

### DETAILED DESCRIPTION OF THE INVENTION

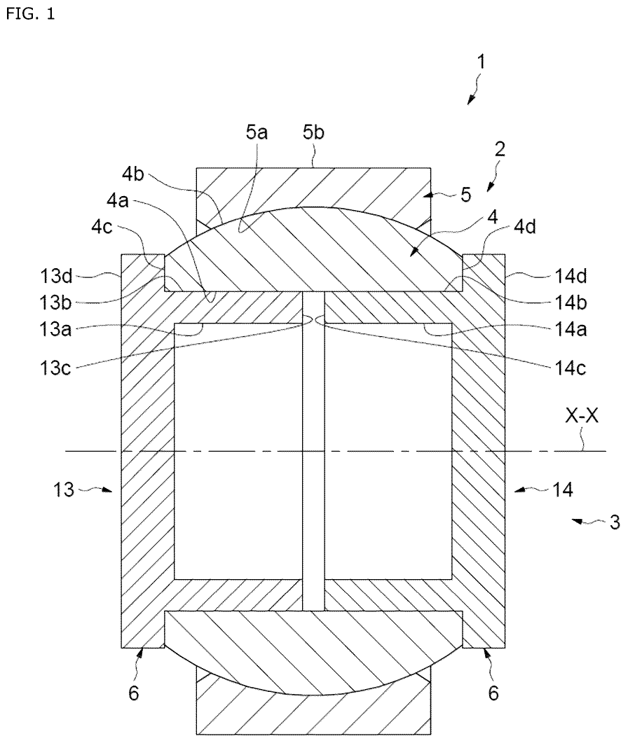

FIG. 1 shows a bearing assembly 1 having an axis X-X′ which, in an assembled configuration, comprises a ball joint 2 and a holding sleeve 3 mounted within the ball joint 2. The ball joint 2 includes an internal ring 4 and an external ring 5 mounted on the internal ring 4.

Specifically, the external ring 5 has a concave spherical internal surface 5a mounted on the spherical external surface 4b of the internal ring 4, a cylindrical external surface 5b radially opposing the internal surface 5a, and two opposing radial front faces (not indicated) axially delimiting the internal surface 5a and the external surface 5b.

The internal surface 5a of the external ring 5 and the external surface 4b of the internal ring 4 are of complementary shape. The external ring 5 may have a solid spherical shape or be produced in two parts, or even have indentations on the external surface 5b.

The internal ring 4 has a convex spherical external surface 4b, an internal surface 4a forming a cylindrical bore radially opposing the external surface 4b, and two radial opposing front faces 4c, 4d axially delimiting the internal surface 4a and the external surface 4b of the internal ring 4.

The internal ring 4 may be split and produced in a plurality of parts bearing against one another according to one or more planes passing through the axis X-X′. The internal ring 4 may also be formed of one piece (i.e., one piece construction). These different configurations of the internal ring 4 are detailed in the remainder of the description.

The internal ring 4 and the external ring 5 may be produced from or formed of steel, titanium, nickel alloy, bronze, or any other appropriate material.

The holding sleeve 3 having the axis X-X′ has an annular shape and is formed to be mounted within the bore 4a of the internal ring 4.

In the illustrated example, the holding sleeve 3 is composed of a first part 13 and a second part 14. Each part 13, 14 of the holding sleeve 3 has a cylindrical external surface 13b, 14b, respectively, mounted within the bore 4a of the internal ring 4 of the ball joint 2.

Each part 13, 14 of the holding sleeve 3 respectively comprises a cylindrical internal surface 13a, 14a forming a bore and two radial opposing front faces 13c, 13d and 14c, 14d axially delimiting the internal surfaces 13a, 14a and the external surfaces 13b, 14b.

Alternatively, the holding sleeve 3 may be produced in an integral assembly.

In order to understand more clearly how the holding sleeve 3 is secured in the internal ring 4 of the bearing assembly 1, the features of the internal ring 4 and the holding sleeve 3 will be described in greater detail below.

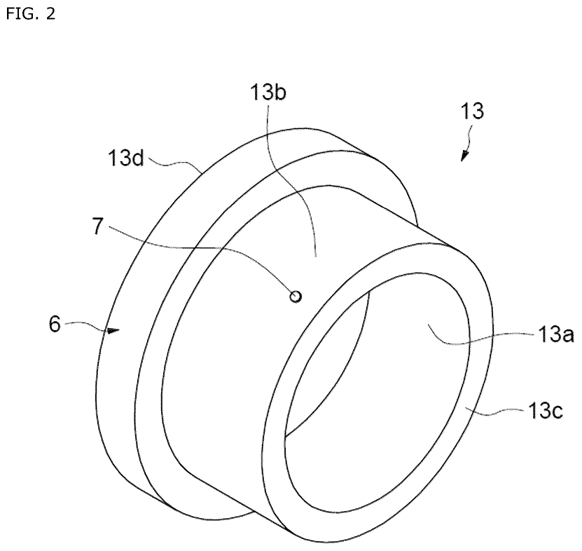

FIG. 2 illustrates the first part 13 of the holding sleeve 3 of the bearing assembly 1 according to a first embodiment of the invention. In this embodiment, the holding sleeve 3 is produced of two identical parts 13, 14 having the same features. However, only the first part 13 of the holding sleeve 3 will be described in detail herein.

The holding sleeve 3 can be produced from materials similar to those of the internal ring 4 and the external ring 5 of the bearing assembly 1. At one of its axial ends, the first part 13 of the holding sleeve 3 may have a flange 6 forming a rim which extends radially toward the outside or radially outwardly. The flange 6 thus serves as an axial abutment for the internal ring 4, limiting its displacement in an axial direction.

The first part 13 of the holding sleeve 3 includes an axial retaining member 7 on the external surface 13b. In FIG. 2, the axial retaining member 7 is a lug attached to the external surface 13b of the first part 13 of the holding sleeve 3. As used in the present disclosure, the term “attached” is understood to mean that the axial retaining member 7 is a separate element which is added and fixed to the external surface 13b of the first part 13 of the holding sleeve 3.

The retaining member 7 can be fixed to the external surface 13b of the first part 13 of the holding sleeve 3, for example by screwing, adhesive bonding or welding. Moreover, the retaining member 7 can be inserted into a housing provided on the external surface of the holding sleeve. The fixing of the axial retaining member 7 permits a precise adjustment of the position of the retaining member 7 relative to the grooves 9, 10 of the internal ring 4, which will be described below, and simpler maintenance, not requiring the entire replacement of the holding sleeve 3.

The axial retaining member 7 extends radially outwardly from the external surface 13b of the first part 13 of the holding sleeve 3. The axial retaining member 7 thus extends perpendicularly to the axis of rotation X-X′ of the first part 13 of the holding sleeve 3, but may alternatively be inclined by a predefined angle relative to the axis of rotation X-X′ of the first part 13 of the holding sleeve 3.

The axial retaining member 7 may have a cylindrical or spherical shape or even a more complex, non-geometric shape, optimized for arrangement on the external surface 13b of the first part 13 of the holding sleeve 3.

The axial retaining member 7 may be manufactured from different materials, such as steel, aluminum, a polymer, etc., as a function of the mechanical stresses associated with assembling the bearing assembly 1.

The axial retaining member 7 can be located at any point on the external surface 13b of the first part 13 of the holding sleeve 3, for example in the center thereof, eccentrically, or in the vicinity of the edge of the first part 13 of the holding sleeve 3 to facilitate the engagement into or within the axial groove 9a and the circumferential groove 10a of the internal surface 4a of the internal ring 4.

The external surface 13b of the first part 13 of the holding sleeve 3 can also include a plurality of the axial retaining members 7 distributed over the external surface 13b.

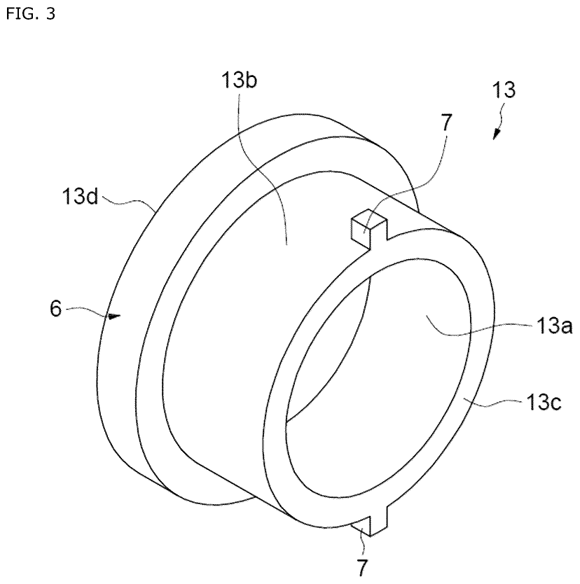

A further exemplary embodiment of the holding sleeve 3 is illustrated in FIG. 3. Similarly, in this embodiment, only the first part 13 of the holding sleeve 3 is shown.

While preserving the general features described above, the first part 13 of the holding sleeve 3 includes at least two axial retaining members 7, provided in the form of a lug formed in one piece, and thus integral with the first part 13 of the holding sleeve 3.

Advantageously, the first part 13 of the holding sleeve 3 comprises or includes a marking (not illustrated) on one of these front faces, in particular on the visible front face 13d when the bearing assembly 1 is assembled.

Thus, during a disassembly operation of the bearing assembly 1, the marking makes it possible to locate rapidly the position of the axial retaining member 7. This facilitates the disengagement of the axial retaining member 7 from the first axial groove 9a and circumferential groove 10a and the separation of the first part 13 of the holding sleeve 3 from the internal ring 4.

With reference to FIGS. 2 and 3, the features described for the first part 13b of the holding sleeve 3 apply, with the necessary changes or modifications being made, to the second part 14 of the holding sleeve 3.

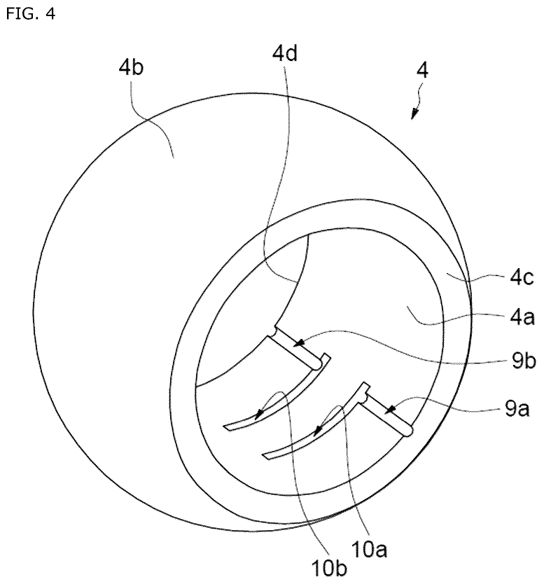

FIG. 4 illustrates an internal ring 4 designed according to a first embodiment of the invention. In this embodiment, the internal surface 4a of the internal ring 4 comprises a first axial groove 9a and a second axial groove 9b and a first circumferential groove 10a and a second circumferential groove 10b.

The first axial groove 9a is machined on the internal surface 4a of the internal ring 4 parallel to the axis of rotation X-X′ of the internal ring 4 and extends respectively from a front face 4c of the internal ring 4 to the internal surface 4a of the internal ring 4.

The second axial groove 9b is machined on the same internal surface 4a of the internal ring 4 and extends from the other front face 4d.

The front faces 4c, 4d of the internal ring 4 serve as a point of entry for the at least one axial retaining member 7 fixed to each part 13, 14 of the holding sleeve 3, permitting an engagement of the parts 13, 14 of the holding sleeve 3 respectively in the first axial groove 9a and the second axial groove 9b.

The circumferential grooves 10a, 10b are machined on the same internal surface 4a of the internal ring 4 and extend perpendicularly to the axis of rotation X-X′ of the internal ring 4. The circumferential grooves 10a, 10b can be machined on the entire internal surface 4a of the internal ring 4 or merely on a specific portion of the internal surface 4a. Each circumferential groove 10a, 10b extends from an axial groove 9a, 9b, such that the circumferential grooves 10a, 10b are connected to the axial grooves 9a, 9b.

With reference to FIG. 4, each assembly formed by a corresponding axial groove 9a, 9b and circumferential groove 10a, 10b defines a guide profile for the axial retaining member 7 of the holding sleeve 3. The guide profile may have an “L-shaped” or angled configuration, or any other configuration providing a direct and uninterrupted path for the axial retaining member 7.

The axial grooves 9a, 9b and circumferential grooves 10a, 10b can also have a rectangular cross section, having a width and a depth capable of permitting the insertion and cooperation with the axial retaining member 7 of each part 13, 14 of the holding sleeve 3.

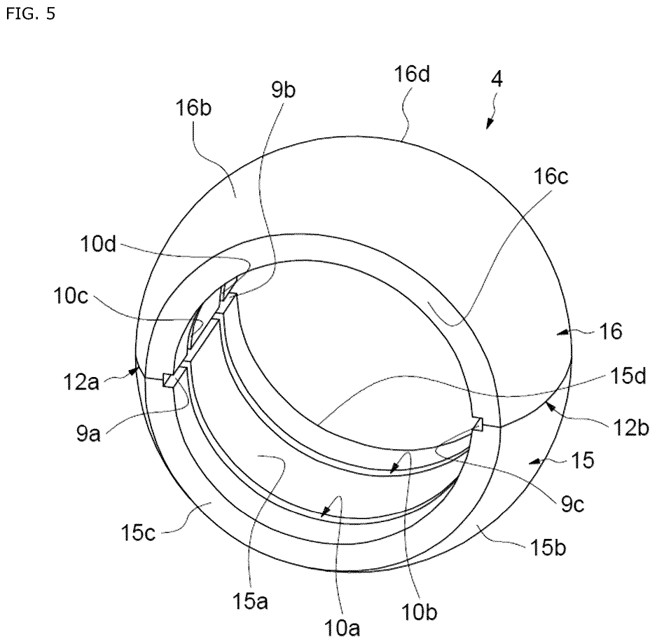

FIG. 5 illustrates a second embodiment of the internal ring 4. This particular aspect of the invention describes a variant of the bearing assembly 1 where the internal ring 4 is axially split. Specifically, the internal ring 4 is divided into two, preferably equal, parts forming two internal half-rings 15, 16.

The split configuration of the internal ring 4 makes it possible to facilitate the assembly of the bearing assembly 1, in particular in applications where access is limited.

The two internal half-rings 15, 16 are in contact with one another, thus forming two joining zones 12a, 12b. In this embodiment, the axial grooves 9a, 9b, 9c, 9d are formed by the assembly of the two half-rings 15, 16.

Each half-ring 15, 16 is machined so that the join of the two half-rings 15, 16 creates the spacing forming the axial grooves 9a, 9b, 9c, 9d from the corresponding front faces 15c, 15d, 16c, 16d of the internal half-rings 15, 16.

The circumferential grooves 10a, 10b, 10c, 10d extend from the axial grooves 9a, 9b, 9c, 9d and extend continuously over the entire internal surface 15a, 16a of each internal half-ring 15, 16.

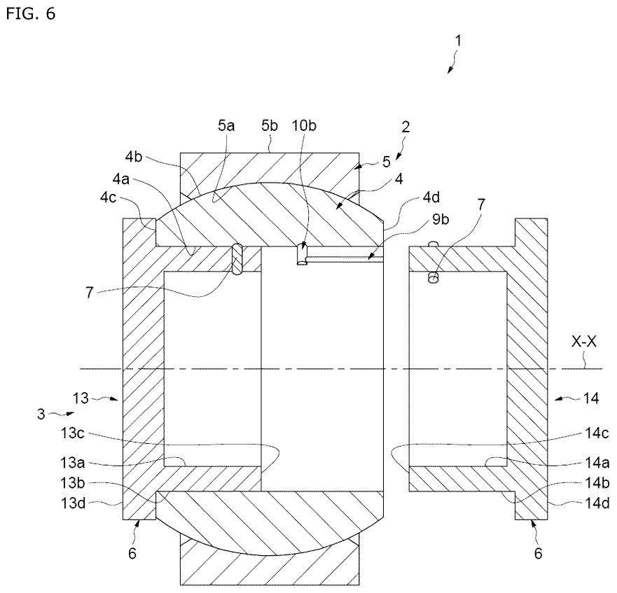

FIG. 6 illustrates a sectional view of an intermediate step of the assembly process of a bearing assembly 1 according to FIG. 1 but partially assembled in this case.

The holding sleeve 3 is in a configuration in two parts 13, 14 according to FIG. 1, with the first part 13 of the holding sleeve 3 already assembled in the internal surface 4a of the internal ring 4 and held in place by the axial retaining member 7 which is engaged in the first circumferential groove 10a of the internal ring 4.

The second part 14 of the holding sleeve 3 is shown before its insertion in the internal surface 4a of the internal ring 4. The axial groove 9b and the circumferential groove 10b of the internal surface 4a of the internal ring 4 are visible.

Thus, to assemble a bearing assembly 1 according to the invention, the first step consists in inserting the internal ring 4 in the external ring 5. The internal ring 4 is positioned concentrically relative to the external ring 5, ensuring a precise alignment of the two components. This insertion makes it possible to create a housing capable of receiving the holding sleeve 3, while guaranteeing the mechanical stability of the assembly during the subsequent phases of the method.

Once the internal ring 4 is in place, the second part 14 of the holding sleeve 3 is brought into position in the bore 4a of the internal ring 4. To achieve this, the second part 14 of the holding sleeve 3 is inserted so as to align the axial retaining member 7 with the second axial groove 9b, providing a first mechanical engagement. In this case, the opening of the second axial groove 9b on the front face 4d of the internal ring 4 permits the axial retaining member 7 of the holding sleeve 3 to enter the axial groove 9b and to be engaged therein.

Once the axial retaining member 7 is engaged in the axial groove 9b, a relative rotational movement is applied between the second part 14 of the holding sleeve 3 and the internal ring 4; i.e., at least one of the second part 14 of the holding sleeve 3 and the internal ring 4 is rotationally displaced relative to the other one of the sleeve second part 14 and the ring 4.

During such rotation, the axial retaining member 7 passes through the guide profile formed by the continuity of the axial groove 9b and circumferential groove 10b until fully engaging within the second circumferential groove 10b, thus ensuring the axial blocking of the second part 14 of the holding sleeve 3 relative to the internal ring 4.

The axial retaining member 7 of each part 13, 14 of the holding sleeve 3 is designed to be engaged in one of the axial grooves 9a, 9b and circumferential grooves 10a, 10b of the internal ring 4 and to be displaced along the corresponding grooves 9a, 9b and 10a, 10b, in order to ensure the axial blocking of the holding sleeve 3.

The configuration as illustrated by the first part 13 of the holding sleeve 3 is now present. This assembly method is based on a combination of an initial axial guidance, by the presence of the first axial groove 9a and the second axial groove 9b, and a final locking achieved by the presence of the first circumferential groove 10a and the second circumferential groove 10b. The holding sleeve 3 is held securely in position without requiring external elements, such as nuts or additional fixings. Further, the relative rotation between the components permits a simplified assembly of the bearing assembly 1.

The invention is not limited to the specific configurations of the internal ring and the holding sleeve described above. More specifically, with reference to the exemplary embodiments of FIGS. 1 and 6, the arrangement of the first axial groove 9a and the second axial groove 9b and the first circumferential groove 10a and the second circumferential groove 10b and the axial retaining member 7 can be reversed without affecting the assembling of the bearing assembly 1.

Thus, the axial grooves 9a, 9b and circumferential grooves 10a, 10b can be machined either on the internal surface 4a of the internal ring 4 or on the external surface 13b, 14b of each part 13, 14 of the holding sleeve 3.

Similarly, the axial retaining member 7 can be fixed either to the external surface 13b, 14b of each part 13, 14 of the holding sleeve 3 or to the internal surface 4a of the internal ring 4.

This flexibility of design, enabling the arrangement of the grooves 9 and 10 and the axial retaining member 7 to be reversed, makes it possible to provide an adaptability to different stresses, in particular in terms of space requirement and integration in restricted environments.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing assembly comprising:
a ball joint including an internal ring having an internal surface forming a bore and a spherical external surface, an external ring having a spherical internal surface mounted on the spherical external surface of the internal ring and a holding sleeve having an external surface mounted within the internal surface of the internal ring;
wherein one of the internal surface of the internal ring and the external surface of the holding sleeve is provided with at least one axial groove extending from a front face of the internal ring or a front face of the holding sleeve and at least one circumferential groove extending from the at least one axial groove; and
wherein the other one of the internal surface of the internal ring and the external surface of the holding sleeve is provided with at least one axial retaining member configured to be engaged inside the at least one axial groove and the at least one circumferential groove so as to axially block the holding sleeve relative to the internal ring.

2. The bearing assembly according to claim 1, wherein the holding sleeve includes two separate parts, each part being provided either with one of the at least one axial retaining member or with one of the at least one axial groove and one of the least one circumferential groove.

3. The bearing assembly according to claim 1, wherein the at least one axial retaining member includes at least one lug protruding relative to the other one of the internal surface of the internal ring and the external surface of the holding sleeve.

4. The bearing assembly according to claim 3, wherein the lug is integrally formed with the other one of the internal surface of the internal ring and the external surface of the holding sleeve.

5. The bearing assembly according to claim 3, wherein the lug is attached to the other one of the internal surface of the internal ring and the external surface of the holding sleeve.

6. The bearing assembly according to claim 1, wherein the internal ring includes two internal half-rings contacting each other and forming at least one joining zone, each joining zone being provided with at least one axial groove.

7. The bearing assembly according to claim 6, wherein the internal surface of each half-ring has at least one circumferential groove extending from the axial groove.

8. The bearing assembly according to claim 6, wherein the holding sleeve has at least one marking on a front face to indicate a position of the axial retaining member of the holding sleeve.

9. A method of assembling a bearing assembly according to claim 1, the method comprising the steps of:
inserting the internal ring into the external ring;
engaging the axial retaining member of one of the internal surface of the internal ring and the external surface of the holding sleeve with the at least one axial groove of the other one of the internal surface of the internal ring and the external surface of the holding sleeve; and
relatively rotationally displacing at least one of the holding sleeve and the internal ring so as to engage the axial retaining member in the circumferential groove of one of the internal surface of the internal ring and the external surface of the holding sleeve to ensure axial blocking of the holding sleeve relative to the internal ring.
